(19) United States
(12) Patent Application Publication
(10) Pub. No.: US 2004/0103285 A1
(43) Pub. Date: May 27, 2004

(54) System for transmitting and receiving encrypted information

(76) Inventors: Masayoshi Nishitani, Yokosuka-shi (JP); Kenjiro Ueda, Yokosuka-shi (JP); Takayuki Sugahara, Yokosuka-shi (JP)

Correspondence Address: LOUIS WOO, LAW OFFICE OF LOUIS WOO, 717 NORTH FAYETTE STREET, ALEXANDRIA, VA, 22314, US

(21) Appl. No.: 10/661,481

(22) Filed: Sep. 15, 2003

(30) Foreign Application Priority Data
Nov. 26, 2002 (JP) 2002-341590

(51) Int. Cl. G06F 1/24

(52) U.S. Cl. 713/176

(57) ABSTRACT

In an encrypted information recording apparatus, a digital contents signal is divided into data blocks. A statistical quantity of the digital contents signal is calculated for every data block. A corrective quantity is calculated from encrypted information and the calculated statistical quantity. First random numbers are changed into second random numbers in response to the calculated corrective quantity. A signal representative of the second random numbers is added to the digital contents signal so that the encrypted information is embedded therein and thereby a digital information signal is generated. The digital information signal is transmitted from the recording apparatus to an encrypted information reproducing apparatus. In the reproducing apparatus, the digital information signal is divided into data blocks. The statistical quantity of the digital information signal is calculated for every data block. The encrypted information is extracted from the digital information signal in response to the calculated statistical quantity.

### BACKGROUND OF THE INVENTION

1. Field of the Invention

This invention generally relates to a system for transmitting and receiving encrypted information. This invention specifically relates to a system for adding encrypted information to contents information, transmitting the addition-result information, receiving encrypted-information-added contents information, and separating encrypted information from the received contents information. In addition, this invention generally relates to a method of transmitting and receiving encrypted information. This invention specifically relates to a method of adding encrypted information to contents information, transmitting the addition-result information, receiving encrypted-information-added contents information, and separating encrypted information from the received contents information. Furthermore, this invention relates to an apparatus for embedding auxiliary information in contents information, and an apparatus for separating auxiliary information from auxiliary-information-added contents information. In addition, this invention relates to a computer program for embedding encrypted information in contents information, and a computer program for separating encrypted information from encrypted-information-added contents information.

2. Description of the Related Art

H. Ogawa et al. have reported “A Copyright Information Embedding Method using DCT for Digital Movies”, SCIS'97-31G, which discloses watermarking methods suitable for MPEG bit streams. The watermarking methods are based on modifying DCT coefficients, motion vectors, and quantizer matrices to embed copyright information in digital contents (movies). The watermarking method based on modifying DCT coefficients is better than those based on modifying motion vectors and quantizer matrices in resistance to an editing-using or compression-using attack intended to erase the copyright information from the digital contents.

J. Ohnishi et al. have reported “A Watermarking Scheme to Image Data by PN Sequence”, SCIS'97-26B, which discloses a data hiding method using a PN sequence in the spread spectrum technique. In the data hiding method, an original image signal is converted into a spread spectrum in response to a PN sequence. A narrow band signal to stand for a signature is added to the spread spectrum, that is, a wideband channel of which an original image is spread. When the signature-added spread spectrum is inversely converted into the normal image by the PN sequence, the signature signal is spread over the normal-image signal. In other words, the signature signal is embedded in the normal-image signal. The spread signature signal is low in power, and hence hardly acts as noise with respect to the original image. Accordingly, the signature-added image is substantially the same as the original image. When the signature-added image signal is spread by the PN sequence, the signature signal is reproduced.

The watermarking methods reported by H. Ogawa et al. and the watermarking scheme reported by J. Ohnishi et al need complicated signal processing which includes image signal conversion taking a lot of time. Hardware and software for implementing these methods and scheme tend to be high in cost. When a signal which results from modifying DCT coefficients to embed copyright information in digital contents is processed by a low pass filter, the embedded copyright information is apt to damage.

### SUMMARY OF THE INVENTION

It is a first object of this invention to provide a simple system for transmitting and receiving encrypted information.

It is a second object of this invention to provide a simple method of transmitting and receiving encrypted information.

It is a third object of this invention to provide a simple apparatus for embedding auxiliary information in contents information.

It is a fourth object of this invention to provide a simple apparatus for separating auxiliary information from auxiliary-information-added contents information.

It is a fifth object of this invention to provide a simple computer program for embedding encrypted information in contents information.

It is a sixth object of this invention to provide a simple computer program for separating encrypted information from encrypted-information-added contents information.

A first aspect of this invention provides a system for transmitting and receiving encrypted information which comprises an encrypted information recording apparatus, an encrypted information reproducing apparatus, and a transmission line connecting the encrypted information recording apparatus and the encrypted information reproducing apparatus, the encrypted information recording apparatus transmitting a digital information signal to the encrypted information reproducing apparatus via the transmission line, the digital information signal resulting from embedding encrypted information in a digital contents signal, the encrypted information reproducing apparatus receiving the digital information signal and reproducing the encrypted information from the digital information signal. The encrypted information recording apparatus comprises first means for dividing the digital contents signal into first data blocks; second means for calculating a statistical quantity of the digital contents signal for every first data block generated by the first means; third means for encrypting information to be embedded into the encrypted information; fourth means for calculating a corrective quantity from the encrypted information and the statistical quantity calculated by the second means; fifth means for changing first random numbers into second random numbers in response to the corrective quantity calculated by the fourth means, and for generating a signal representative of the second random numbers; and sixth means for adding the signal representative of the second random numbers to the digital contents signal for every first data block generated by the first means to embed the encrypted information in the digital contents signal and thereby generate the digital information signal. The encrypted information reproducing apparatus comprises seventh means for dividing the digital information signal into second data blocks corresponding to the first data blocks generated by the first means; eighth means for calculating the statistical quantity of the digital information signal for every second data block generated by the seventh means; ninth means for deciding the encrypted information in the digital information signal in response to the statistical quantity calculated by the eighth means for every second data block generated by the seventh means to extract the encrypted information from the digital information signal; and tenth means for decrypting the encrypted information extracted by the ninth means into the original information to be embedded.

A second aspect of this invention provides a method of transmitting and receiving encrypted information in a system comprising an encrypted information recording apparatus, an encrypted information reproducing apparatus, and a transmission line connecting the encrypted information recording apparatus and the encrypted information reproducing apparatus, the encrypted information recording apparatus transmitting a digital information signal to the encrypted information reproducing apparatus via the transmission line, the digital information signal resulting from embedding encrypted information in a digital contents signal, the encrypted information reproducing apparatus receiving the digital information signal and reproducing the encrypted information from the digital information signal. The method of transmitting and receiving encrypted information comprises a recording-related method and a reproducing-related method. The recording-related method comprises the steps of dividing the digital contents signal into first data blocks; calculating a statistical quantity of the digital contents signal for every first data block; encrypting information to be embedded into the encrypted information; calculating a corrective quantity from the encrypted information and the calculated statistical quantity; changing first random numbers into second random numbers in response to the calculated corrective quantity, and generating a signal representative of the second random numbers; and adding the signal representative of the second random numbers to the digital contents signal for every first data block to embed the encrypted information in the digital contents signal and thereby generate the digital information signal. The reproducing-related method comprises the steps of dividing the digital information signal into second data blocks corresponding to the first data blocks; calculating the statistical quantity of the digital information signal for every second data block; deciding the encrypted information in the digital information signal in response to the calculated statistical quantity of the digital information signal for every second data block to extract the encrypted information from the digital information signal; and decrypting the extracted encrypted information into the original information to be embedded.

A third aspect of this invention provides a computer program for embedding encrypted information in a digital contents signal which comprises the steps of dividing the digital contents signal into data blocks; calculating a statistical quantity of the digital contents signal for every data block; encrypting information to be embedded into the encrypted information; calculating a corrective quantity from the encrypted information and the calculated statistical quantity; changing first random numbers into second random numbers in response to the calculated corrective quantity, and generating a signal representative of the second random numbers; and adding the signal representative of the second random numbers to the digital contents signal for every data block to embed the encrypted information in the digital contents signal.

A fourth aspect of this invention provides an apparatus comprising first means for dividing a digital contents signal into segments; second means for detecting a condition of the digital contents signal for every segment generated by the first means; third means for determining a corrective quantity in response to auxiliary information and the condition detected by the second means; fourth means for changing first random numbers into second random numbers in response to the corrective quantity determined by the third means, and for generating a signal representative of the second random numbers; and fifth means for adding the signal representative of the second random numbers to the digital contents signal for every segment generated by the first means to embed the auxiliary information in the digital contents signal.

A fifth aspect of this invention is based on the fourth aspect thereof, and provides an apparatus wherein the condition detected by the second means is an average-luminance-related condition.

A sixth aspect of this invention is based on the fourth aspect thereof, and provides an apparatus further comprising sixth means for encrypting the auxiliary information before the auxiliary information is used by the third means.

A seventh aspect of this invention provides an apparatus comprising first means for dividing a digital contents signal into segments; second means for detecting an average luminance value of the digital contents signal for every segment generated by the first means; third means for determining a corrective quantity in response to a bit of auxiliary information and the average luminance value detected by the second means for every segment generated by the first means, wherein bits of the auxiliary information are assigned to the segments generated by the first means respectively; fourth means for changing first random numbers into second random numbers in response to the corrective quantity determined by the third means, and for generating a signal representative of the second random numbers; and fifth means for adding the signal representative of the second random numbers to the digital contents signal for every segment generated by the first means to embed the auxiliary information in the digital contents signal and thereby generate a composite digital signal, wherein an average luminance value of every segment of the composite digital signal is either odd or even depending on a logic state of a corresponding bit of the auxiliary information.

An eighth aspect of this invention is based on the seventh aspect thereof, and provides an apparatus further comprising sixth means for encrypting the auxiliary information before the auxiliary information is used by the third means.

A ninth aspect of this invention provides an apparatus comprising first means for dividing a digital information signal into segments; second means for detecting an average luminance value of the digital information signal for every segment generated by the first means; third means for deciding whether the average luminance value detected by the second means is odd or even; and fourth means for detecting auxiliary information in the digital information signal in response to results of the deciding by the third means.

A tenth aspect of this invention is based on the ninth aspect thereof, and provides an apparatus further comprising fifth means for decrypting the auxiliary information detected by the fourth means.

An eleventh aspect of this invention provides a computer program comprising the steps of dividing a digital information signal into segments; detecting an average luminance value of the digital information signal for every segment; deciding whether the detected average luminance value is odd or even; detecting encrypted information in the digital information signal in response to results of the deciding; and decrypting the detected encrypted information.

### BRIEF DESCRIPTION OF THE DRAWINGS

FIG. 1 is a block diagram of a system for transmitting and receiving encrypted information according to a first embodiment of this invention.

FIG. 2 is a diagram of a frame represented by a digital image signal and divided into blocks.

FIG. 3 is a diagram of an example of a set of random integers in a pseudo random number table in FIG. 1.

FIG. 4 is a diagram of a set of random integers which results from modifying the random integer set in FIG. 3.

FIG. 5 is a block diagram of a system for transmitting and receiving encrypted information according to a seventh embodiment of this invention.

FIG. 6 is a flowchart of a segment of a control program for an encrypted information recording apparatus in FIG. 5.

FIG. 7 is a flowchart of a segment of a control program for an encrypted information reproducing apparatus in FIG. 5.

### DETAILED DESCRIPTION OF THE INVENTION

### First Embodiment

A first embodiment of this invention is directed to a system for transmitting and receiving encrypted information. The system includes an encrypted information recording apparatus, an encrypted information reproducing apparatus, and a transmission line connecting the encrypted information recording apparatus and the encrypted information reproducing apparatus. The encrypted information recording apparatus transmits a digital information signal to the encrypted information reproducing apparatus via the transmission line. The digital information signal results from embedding encrypted information in a digital contents signal. The encrypted information reproducing apparatus receives the digital information signal, and reproduces the encrypted information from the digital information signal.

In the encrypted information recording apparatus, the digital contents signal is divided into first data blocks. A statistical quantity of the digital contents signal is calculated for every first data block. For example, an average luminance value related to every first data block is calculated. Alternatively, another statistical quantity such as a statistical color quantity of every first data block may be calculated. Information to be embedded is encrypted to get encrypted information. A corrective quantity is calculated from the encrypted information and the calculated statistical quantity. First random numbers are changed into second random numbers in response to the calculated corrective quantity. A signal representative of the second random numbers is added to the digital contents signal for every first data block to embed the encrypted information in the digital contents signal and thereby generate the digital information signal. The digital information signal is transmitted from the encrypted information recording apparatus to the encrypted information reproducing apparatus via the transmission line.

The encrypted information reproducing apparatus receives the digital information signal. In the encrypted information reproducing apparatus, the digital information signal is divided into second data blocks corresponding to the first data blocks. The statistical quantity of the digital information signal is calculated for every second data block. The encrypted information in the digital information signal is decided in response to the calculated statistical quantity so that the encrypted information is extracted from the digital information signal. The extracted encrypted information is decrypted into the original information to be embedded.

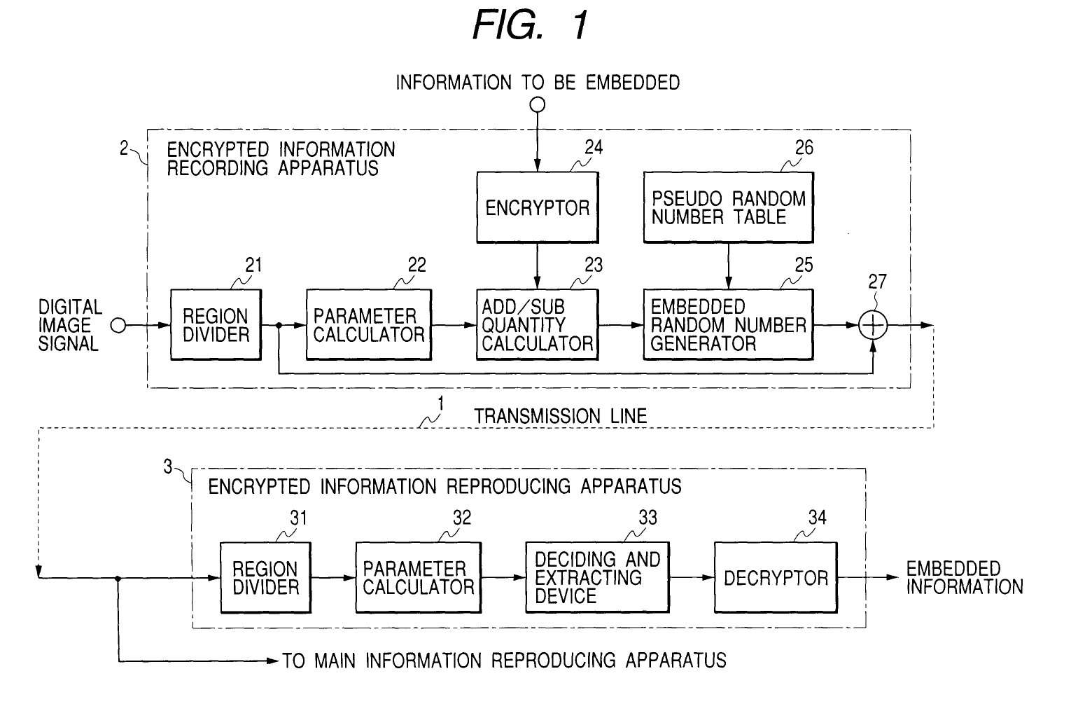

The first embodiment of this invention will be further described hereafter. With reference to FIG. 1, a transmission line or a transmission path 1 extends between an encrypted information recording apparatus 2 and an encrypted information reproducing apparatus 3 which compose a system for transmitting and receiving encrypted information. The recording apparatus 2 is coupled with the transmission line 1 via a communication control device or a communication interface (not shown). Also, the reproducing apparatus 3 is coupled with the transmission line 1 via a communication control device or a communication interface (not shown).

There may be a plurality of recording apparatuses 2 and a plurality of reproducing apparatuses 3 connected with the recording apparatuses 2 via a wired communication network or a wireless communication network.

The transmission line 1 may include a recording medium such as an optical disc, a magneto-optical disc, or a magnetic disc.

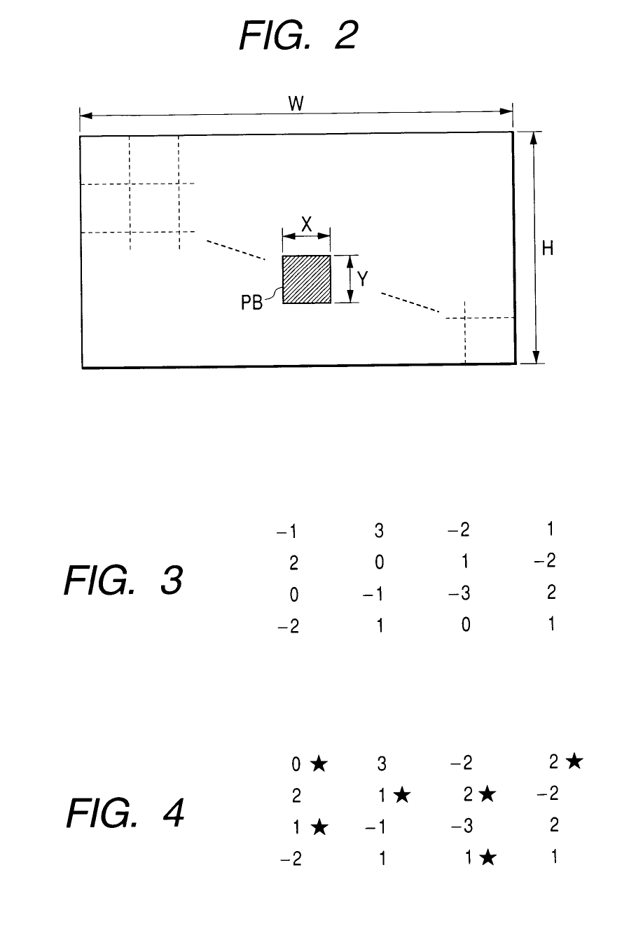

The recording apparatus 2 receives a digital image signal (a digital contents signal) and also information to be embedded. The information to be embedded contains, for example, auxiliary information or copyright information. As shown in FIG. 2, every frame represented by the digital image signal is composed of W pixels in the horizontal direction by H pixels in the vertical direction. The recording apparatus 2 divides every 1-frame-corresponding portion of the digital image signal into segments (data blocks) representing respective equal-size rectangular or square blocks PB composing the frame. Each block PB is composed of X pixels in the horizontal direction by Y pixels in the vertical direction. The recording apparatus 2 encrypts the information to be embedded, and thereby generates encryption-resultant information also referred to as encrypted information. The recording apparatus 2 embeds the encrypted information in the digital image signal on a block-by-block basis. Bits of the encrypted information are assigned to blocks PB, respectively.

With reference back to FIG. 1, the recording apparatus 2 includes a region divider 21, a parameter calculator 22, an addition/subtraction quantity calculator 23, an encryptor 24, an embedded random number generator 25, a pseudo random number table 26, and an adder 27.

The region divider 21 receives the digital image signal. The device 21 divides every 1-frame-corresponding portion of the digital image signal into segments (data blocks) representing respective blocks PB composing the frame. The region divider 21 sequentially outputs 1-block-corresponding segments of the digital image signal to the parameter calculator 22 and the adder 27.

For every block PB, the parameter calculator 22 computes the sum SUM of the luminance values of pixels composing the block PB and being represented by the 1-block-corresponding segment of the digital image signal. For every block PB, the parameter calculator 22 computes a mean or an average AVG among the luminance values of pixels composing the block PB and being represented by the 1-block-corresponding segment of the digital image signal. The parameter calculator 22 outputs a signal representative of the computed luminance value sum SUM and a signal representative of the computed average luminance value AVG to the addition/subtraction quantity calculator 23.

The encryptor 24 receives the information to be embedded. The device 24 encrypts the received information to generate encryption-resultant information (encrypted information). The encryptor 24 outputs the encrypted information to the addition/subtraction quantity calculator 23.

For every block PB, the addition/subtraction quantity calculator 23 computes a corrective luminance value from the encrypted information, the luminance value sum SUM, and the average luminance value AVG. The corrective luminance value is designed to alter the average luminance value AVG for the block PB in response to the encrypted information. As will be made clear later, the corrective luminance value is divided into parts added to or subtracted from the luminance values of some or all of pixels composing the block PB.

Examples of the encryption by the encryptor 24 are as follows. In the case where every 8 bits of the information to be added represents an ASCII (trademark) character, the 8 bits are assigned to 8 successive blocks PB respectively. In this case, the 8 bits compose a 1-character-corresponding portion of encrypted information. Provided that the recording side will be in harmony with a reproducing side, the information to be embedded may be encoded into second information of a Huffman code or another code. In this case, bits of the second information are assigned to successive blocks PB respectively. The second information is encrypted information.

As will be made clear later, the addition/subtraction quantity calculator 23 and other devices implement a process of altering the average luminance value AVG for each block PB in response to the encrypted information. The luminance altering process relates to conditions of the embedding of the encrypted information in the digital image signal, and conforms to rules set between the recording apparatus 2 and the reproducing apparatus 3.

The luminance altering process is designed as follows. Bits of the encrypted information are assigned to blocks PB, respectively. When a bit of the encrypted information is “1”, the average luminance value AVG of a corresponding block PB is altered to or maintained at an even number (an even value). When a bit of the encrypted information is “0”, the average luminance value AVG of a corresponding block PB is altered to or maintained at an odd number (an odd value).

The addition/subtraction quantity calculator 23 will be further described. The luminance value sum SUM represented by the signal outputted from the parameter calculator 22 to the addition/subtraction quantity calculator 23 is expressed as follows.

$$S U M = {\sum }_{i = 1}^{N} P i \qquad ( 1 )$$

where Pi denotes the luminance value of each pixel in a block PB, and N denotes the total number of pixels composing the block PB. The average luminance value AVG represented by the signal outputted from the parameter calculator 22 to the addition/subtraction quantity calculator 23 is expressed as follows.

AVG=SUM//N (2)

where // denotes an operator for division with counting division-result fractions of 0.5 and over as a unit and cutting away the rest.

The addition/subtraction quantity calculator 23 decides whether a bit of the encrypted information is “0” or “1”, and whether the average luminance value AVG of a corresponding block PB is odd or even.

In the case where a bit of the encrypted information is “1” and the average luminance value AVG of a corresponding block PB is odd, the addition/subtraction quantity calculator 23 operates as follows. The addition/subtraction quantity calculator 23 computes a raised average AVG1 equal to the average luminance value AVG plus “1”, and a lowered average AVG2 equal to the average luminance value AVG minus “1”. The addition/subtraction quantity calculator 23 multiplies the raised average AVG1 by the 1-block pixel number N to get a raised sum SUM1. The raised average AVG1 and the raised sum SUM1 are expressed as follows.

SUM1=AVG1·N, AVG1=AVG+1 (3)

Similarly, the addition/subtraction quantity calculator 23 multiplies the lowered average AVG2 by the 1-block pixel number N to get a lowered sum SUM2. The lowered average AVG2 and the lowered sum SUM2 are expressed as follows.

SUM2=AVG2·N, AVG2=AVG−1 (4)

The addition/subtraction quantity calculator 23 computes the absolute value δ1 of the difference between the luminance value sum SUM and the raised sum SUM1 according to the following equation.

δ1=|SUM−SUM1| (5)

In addition, the addition/subtraction quantity calculator 23 computes the absolute value δ2 of the difference between the luminance value sum SUM and the lowered sum SUM2 according to the following equation.

δ2=|SUM−SUM2| (6)

The addition/subtraction quantity calculator 23 compares the difference's absolute values δ1 and δ2 to decide which of the two is smaller. When the difference's absolute value δ1 is smaller, the addition/subtraction quantity calculator 23 sets a difference value A equal to the raised sum SUM1 minus the luminance value sum SUM (Δ=SUM1−SUM). Otherwise, the addition/subtraction quantity calculator 23 sets the difference value Δ equal to the lowered sum SUM2 minus the luminance value sum SUM (Δ=SUM2−SUM). In this way, smaller one of the difference's absolute values δ1 and δ2 is selected, and the difference value Δ is set according to the selected difference's absolute value. This design suppresses deterioration of a picture represented by a digital image signal containing embedded information. The difference value Δ is a corrective luminance value. The addition/subtraction quantity calculator 23 outputs a signal representative of the difference value (corrective luminance value) Δ to the embedded random number generator 25.

Alternatively, the addition/subtraction quantity calculator 23 may operate as follows. The addition/subtraction quantity calculator 23 computes only a raised average AVG1 equal to the average luminance value AVG plus “1” (AVG1=AVG+1). The addition/subtraction quantity calculator 23 multiplies the raised average AVG1 by the 1-block pixel number N to get a raised sum SUM1. The addition/subtraction quantity calculator 23 always sets a difference value Δ equal to the raised sum SUM1 minus the luminance value sum SUM (Δ=SUM1−SUM). The addition/subtraction quantity calculator 23 outputs a signal representative of the difference value (corrective luminance value) Δ to the embedded random number generator 25.

In the case where a bit of the encrypted information is “1” and the average luminance value AVG of a corresponding block PB is even, the addition/subtraction quantity calculator 23 operates as follows. The addition/subtraction quantity calculator 23 sets the difference value Δ to “0” (Δ=0). The addition/subtraction quantity calculator 23 outputs a signal representative of the difference value (corrective luminance value) Δ to the embedded random number generator 25.

Alternatively, the addition/subtraction quantity calculator 23 may operate as follows. The addition/subtraction quantity calculator 23 computes an average-based sum SUM3 from the average luminance value AVG and the 1-block pixel number N according to the following equation.

SUM3=AVG·N (7)

The addition/subtraction quantity calculator 23 sets the difference value Δ equal to the average-based sum SUM3 minus the luminance value sum SUM (Δ=SUM3−SUM). The addition/subtraction quantity calculator 23 outputs a signal representative of the difference value (corrective luminance value) Δ to the embedded random number generator 25.

In the case where a bit of the encrypted information is “0” and the average luminance value AVG of a corresponding block PB is even, the addition/subtraction quantity calculator 23 operates as follows. The addition/subtraction quantity calculator 23 computes a raised average AVG1 equal to the average luminance value AVG plus “1”, and a lowered average AVG2 equal to the average luminance value AVG minus “1”. The addition/subtraction quantity calculator 23 multiplies the raised average AVG1 by the 1-block pixel number N to get a raised sum SUM1. Similarly, the addition/subtraction quantity calculator 23 multiplies the lowered average AVG2 by the 1-block pixel number N to get a lowered sum SUM2. The addition/subtraction quantity calculator 23 computes the absolute value δ1 of the difference between the luminance value sum SUM and the raised sum SUM1 according to the previously-indicated equation (5). In addition, the addition/subtraction quantity calculator 23 computes the absolute value δ2 of the difference between the luminance value sum SUM and the lowered sum SUM2 according to the previously-indicated equation (6). The addition/subtraction quantity calculator 23 compares the difference's absolute values δ1 and δ2 to decide which of the two is smaller. When the difference's absolute value δ1 is smaller, the addition/subtraction quantity calculator 23 sets a difference value Δ equal to the raised sum SUM1 minus the luminance value sum SUM (Δ=SUM1−SUM). Otherwise, the addition/subtraction quantity calculator 23 sets the difference value Δ equal to the lowered sum SUM2 minus the luminance value sum SUM (Δ=SUM2−SUM). In this way, smaller one of the difference's absolute values δ1 and δ2 is selected, and the difference value Δ is set according to the selected difference's absolute value. This design suppresses deterioration of a picture represented by a digital image signal containing embedded information. The addition/subtraction quantity calculator 23 outputs a signal representative of the difference value (corrective luminance value) Δ to the embedded random number generator 25.

Alternatively, the addition/subtraction quantity calculator 23 may operate as follows. The addition/subtraction quantity calculator 23 computes only a raised average AVG1 equal to the average luminance value AVG plus “1” (AVG1=AVG+1). The addition/subtraction quantity calculator 23 multiplies the raised average AVG1 by the 1-block pixel number N to get a raised sum SUM1. The addition/subtraction quantity calculator 23 always sets a difference value Δ equal to the raised sum SUM1 minus the luminance value sum SUM (A=SUM1−SUM). The addition/subtraction quantity calculator 23 outputs a signal representative of the difference value (corrective luminance value) Δ to the embedded random number generator 25.

In the case where a bit of the encrypted information is “0” and the average luminance value AVG of a corresponding block PB is odd, the addition/subtraction quantity calculator 23 operates as follows. The addition/subtraction quantity calculator 23 sets the difference value Δ to “0” (Δ=0). The addition/subtraction quantity calculator 23 outputs a signal representative of the difference value (corrective luminance value) Δ to the embedded random number generator 25.

Alternatively, the addition/subtraction quantity calculator 23 may operate as follows. The addition/subtraction quantity calculator 23 computes an average-based sum SUM3 from the average luminance value AVG and the 1-block pixel number N according to the previously-indicated equation (7). The addition/subtraction quantity calculator 23 sets the difference value Δ equal to the average-based sum SUM3 minus the luminance value sum SUM (Δ=SUM3−SUM). The addition/subtraction quantity calculator 23 outputs a signal representative of the difference value (corrective luminance value) Δ to the embedded random number generator 25.

The pseudo random number table 26 is represented by a signal stored in a suitable memory such as a ROM. The pseudo random number table 26 contains a set of preset random integers. A mean (an average) among the random integers is equal to “0”. The total number of the random integers is equal to the 1-block pixel number N. The random integers in the table 26 are assigned to pixels composing one block PB, respectively. The embedded random number generator 25 reads out the signal representative of the pseudo random number table 26 from the memory, and saves the read-out signal in its internal memory. The embedded random number generator 25 accesses the random integers in the saved table 26. The embedded random number generator 25 alters or modifies one or more of the random integers in response to the difference value (corrective luminance value) Δ. The embedded random number generator 25 sequentially outputs signals representative of the resultant random integers to the adder 27.

Specifically, the embedded random number generator 25 decides whether or not the difference value Δ is positive. In the case where the difference value Δ is positive, the embedded random number generator 25 accesses the random integers in the saved table 26 one by one in the order from the lowest absolute value toward the greatest absolute value and increments the accessed random integers by “1” to get incremented random integers (modified random integers) until the total number of the accessed and incremented random integers reaches the difference value Δ. Thus, the embedded random number generator 25 successively accesses and increments random inters of “0”, random integers of “±1”, random integers of “±2”, . . . in the saved table 26. The embedded random number generator 25 halts accessing and incrementing the random integers when the total number of the accessed and incremented random integers reaches the difference value Δ. Therefore, the original random integer set is changed into a modified set having the modified random integers and some of the original random integers. For a better understanding, a simple example will be explained below. It is assumed that the difference value Δ is equal to “6” and there is a set of sixteen random integers in the saved table 26 which are equal to values shown in FIG. 3. In this case, three random integers of “0” in FIG. 3 are first accessed and are incremented by “1”. Then, three among six random integers of “±1” which have former addresses in FIG. 3 are accessed and are incremented by “1”. As a result, random integers, the total number of which is equal to the difference value Δ (“6”), are incremented by “1”. Thus, the random integer set in FIG. 3 is changed into a modified set having contents shown in FIG. 4 where the incremented random integers are followed by “★”.

In the case where the difference value Δ is not positive, the embedded random number generator 25 accesses the random integers in the saved table 26 one by one in the order from the lowest absolute value toward the greatest absolute value and decrements the accessed random integers by “1” to get decremented random integers (modified random integers) until the total number of the accessed and decremented random integers reaches the absolute value of the difference value Δ. Thus, the embedded random number generator 25 successively accesses and decrements random inters of “0”, random integers of “±1”, random integers of “±2”, . . . in the saved table 26. The embedded random number generator 25 halts accessing and decrementing the random integers when the total number of the accessed and decremented random integers reaches the absolute value of the difference value Δ. Therefore, the original random integer set is changed into a modified set having the modified random integers and some of the original random integers.

The embedded random number generator 25 sequentially outputs signals representative of the random integers in the modified set to the adder 27. The random integers in the modified set are assigned to pixels composing one block PB, respectively.

The digital image signal outputted from the region divider 21 to the adder 27 and the signal outputted from the embedded random number generator 25 to the adder 27 are synchronized with each other regarding pixels. The device 27 adds the output signal of the embedded random number generator 25 to the luminance signal in the digital image signal on a pixel-by-pixel basis. Specifically, the device 27 adds a random integer represented by the output signal of the embedded random number generator 25 to the luminance value of a corresponding pixel represented by the digital image signal (the output signal of the region divider 21). The addition is implemented for each of pixels composing one block PB so that the digital image signal is converted into a luminance-altered digital image signal. For every block PB, random integers sequentially represented by the output signal of the embedded random number generator 25 depend on a difference value (corrective luminance value) Δ, and the difference value Δ varies in accordance with whether a bit of the encrypted information is “0” or “1”. Thus, for every block PB, an average among the luminance values of pixels represented by the luminance-altered digital image signal depends on the logic state of a corresponding bit of the encrypted information. Furthermore, one or more of the luminance values of pixels represented by the luminance-altered digital image signal are modified from the original in response to the logic state of the corresponding bit of the encrypted information. The adder 27 outputs the luminance-altered digital image signal to the transmission line 1. The luminance-altered digital image signal propagates to the reproducing apparatus 3 along the transmission line 1.

As shown in FIG. 1, the reproducing apparatus 3 includes a region divider 31, a parameter calculator 32, a deciding and extracting device 33, and a decryptor 34.

The region divider 31 receives a luminance-altered digital image signal from the transmission line 1. The device 31 divides every 1-frame-corresponding portion of the received digital image signal into segments (data blocks) representing respective blocks PB composing the frame. The region divider 31 sequentially outputs 1-block-corresponding segments of the digital image signal to the parameter calculator 32.

For every block PB, the parameter calculator 32 computes a mean or an average among the luminance values of pixels composing the block PB and being represented by the 1-block-corresponding segment of the digital image signal as the parameter calculator 22 does. The parameter calculator 32 outputs a signal representative of the computed average luminance value to the deciding and extracting device 33.

For every block PB, the deciding and extracting device 33 determines whether the average luminance value represented by the output signal of the parameter calculator 32 is odd or even. When the average luminance value is odd, the deciding and extracting device 33 outputs a bit of “0” to the decryptor 34 as a corresponding bit of encrypted information. On the other hand, when the average luminance value is even, the deciding and extracting device 33 outputs a bit of “1” to the decryptor 34 as a corresponding bit of encrypted information. For successive blocks, the deciding and extracting device 33 thus outputs a bit sequence to the decryptor 34 which is encrypted information.

The device 34 decrypts the encrypted information (the bit sequence) to recover original information therefrom. The function of the decryptor 34 is inverse with respect to the function of the encryptor 24. The decryptor 34 outputs the recovered information.

It should be noted that also a main information reproducing apparatus (not shown) receives the luminance-altered digital image signal from the transmission line 1.

### Second Embodiment

A second embodiment of this invention is similar to the first embodiment thereof except for design changes mentioned hereafter. In the second embodiment of this invention, the total number of random integers in the table 26 is smaller than the 1-block pixel number N. For example, the total number of random integers in the table 26 is equal to the 1-block pixel number N divided by a predetermined number between “2” and “10”. For every block PB, the set of the random integers in the table 26 is repetitively used.

The corrective luminance value whose parts are added to or subtracted from the luminance values of some or all of pixels composing one block PB is divided by the number of times the set of the random integers in the table 26 is used for the block PB. The result of the division is referred to as a distribution quantity. The embedded random number generator 25 modifies the random integers in response to the distribution quantity.

Pixels composing one block PB is separated into groups each having members to which the random integers in the table 26 are assigned respectively. Preferably, the assignment of the random integers to the in-group pixels is varied from group to group. For example, the read-out start position (the access start position) in the random integer set or the table 26 is changed at random by use of the position of a block PB and the position of a pixel from which the addition or subtraction of the corrective luminance value is commenced. This design prevents a group-related pattern from appearing in a block PB.

### Third Embodiment

A third embodiment of this invention is similar to the first embodiment thereof except for design changes mentioned hereafter. In the third embodiment of this invention, the number of bits composing the encrypted information is smaller than the number of blocks PB composing one frame. Ones are selected from blocks PB composing one frame. The number of selected blocks PB is equal to the number of bits composing the encrypted information. The bits composing the encrypted information are assigned to the selected blocks PB, respectively. The embedding of the encrypted information in the digital image signal is implemented for only the selected blocks PB. It is unnecessary to execute the embedding process for the non-selected blocks PB.

In the case where the number of blocks PB composing one frame is equal to or greater than twice the number of bits composing the encrypted information, the encrypted information may be repetitively embedded in a 1-frame-corresponding segment of the digital image signal. In this case, the encrypted information transmitted via the transmission line 1 has an improved resistance to noise.

### Fourth Embodiment

A fourth embodiment of this invention is similar to the first embodiment thereof except for design changes mentioned hereafter. The fourth embodiment of this invention includes an encrypted information reproducing apparatus which is in harmony with the recording apparatus 2. The reproducing apparatus in the fourth embodiment of this invention differs in reproducing and extracting processes from the reproducing apparatus 3 in the first embodiment of this invention.

### Fifth Embodiment

A fifth embodiment of this invention is similar to the first embodiment thereof except for design changes mentioned hereafter. The fifth embodiment of this invention includes modified region dividers 21 and 31 in harmony with each other. The modified region divider 21 additionally has the function of deciding a region within a block PB in which bits composing encrypted information should be embedded. The modified region divider 31 additionally has the function of deciding a region within a block PB from which bits composing encrypted information should be extracted.

### Sixth Embodiment

A sixth embodiment of this invention is similar to the first embodiment thereof except for design changes mentioned hereafter. The encryption and decryption by an encryptor and a decryptor in the sixth embodiment of this invention are of ones of various known types different from those by the encryptor 24 and the decryptor 34 in the first embodiment of this invention.

### Seventh Embodiment

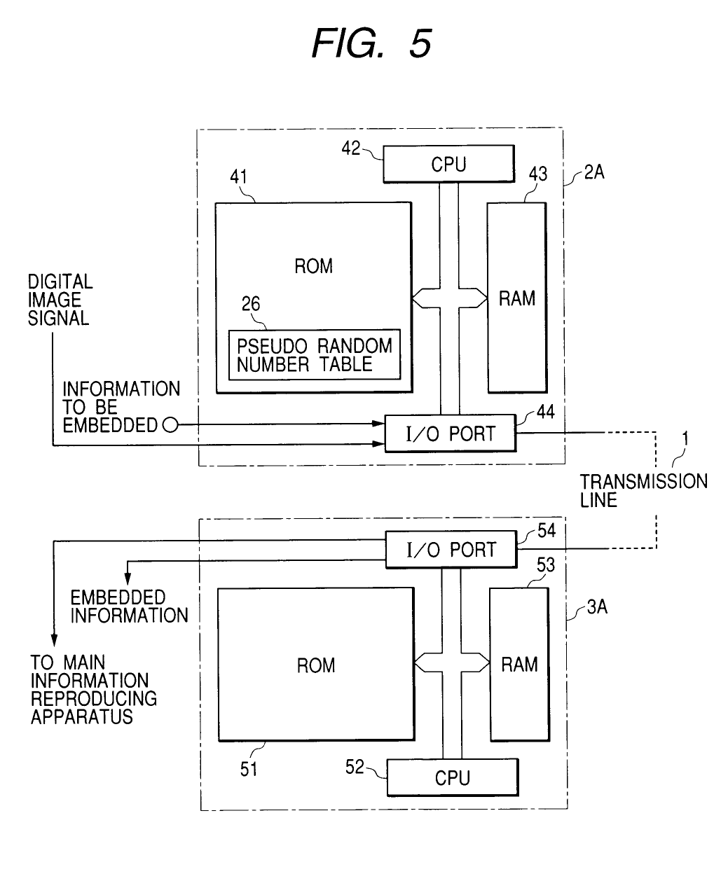

With reference to FIG. 5, a transmission line or a transmission path 1 extends between an encrypted information recording apparatus 2A and an encrypted information reproducing apparatus 3A which compose a system for transmitting and receiving encrypted information. The recording apparatus 2A is coupled with the transmission line 1. Also, the reproducing apparatus 3A is coupled with the transmission line 1.

There may be a plurality of recording apparatuses 2A and a plurality of reproducing apparatuses 3A connected with the recording apparatuses 2A via a wired communication network or a wireless communication network.

The transmission line 1 may include a recording medium such as an optical disc, a magneto-optical disc, or a magnetic disc.

The recording apparatus 2A and the reproducing apparatus 3A are similar to the recording apparatus 2 and the reproducing apparatus 3 in FIG. 1 except for design changes mentioned hereafter.

The recording apparatus 2A includes a microcomputer having a combination of a ROM 41, a CPU 42, a RAM 43, and an I/O port 44. The ROM 41, the CPU 42, the RAM 43, and the I/O port 44 are connected via a bus. The I/O port 44 receives a digital image signal (a digital contents signal) and also information to be embedded. The information to be added contains, for example, auxiliary information or copyright information. The I/O port 44 is coupled with the transmission line 1. The recording apparatus 2A or the microcomputer therein operates in accordance with a control program stored in the ROM 41. During operation of the recording apparatus 2A, a sequence of steps in the control program is executed by the CPU 42. A random number table 26 is provided in the ROM 41.

The control program for the recording apparatus 2A has an encryptor segment which corresponds to the encryptor 24 in FIG. 1. The encryptor segment includes a step of encrypting the information to be embedded according to an encryption algorithm stored in the ROM 41, and thereby generating encryption-resultant information (encrypted information). The encryptor segment also includes a step of storing the encrypted information into the RAM 43. Bits composing the encrypted information have serial ID numbers, respectively. The serial bit ID numbers start from “1”. Examples of the encryption are as follows. In the case where every 8 bits of the information to be embedded represents an ASCII (trademark) character, the 8 bits are assigned to successive blocks PB respectively. In this case, the 8 bits compose a 1-character-corresponding portion of encrypted information. Provided that the recording side will be in harmony with a reproducing side, the information to be embedded may be encoded into second information of a Huffman code or another code. In this case, bits of the second information are assigned to successive blocks PB respectively. The second information is encrypted information.

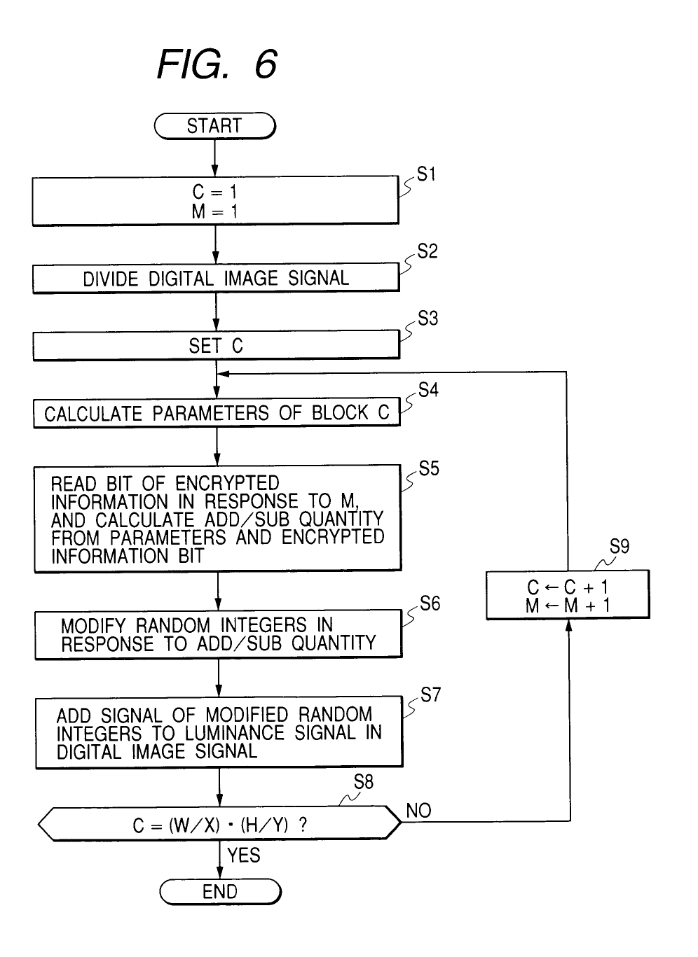

FIG. 6 is a flowchart of a main segment of the control program for the recording apparatus 2A. The main program segment is executed for every frame represented by the digital image signal.

As shown in FIG. 6, a first step S1 of the main program segment initializes variables C and M to “1”. The variable C is used as a counter value C for denoting a block PB which is periodically changed from one to another along a normal scanning order (the left to the right and the top to the bottom in a frame). The variable M is used as a counter value for denoting a bit of the encrypted information which is periodically changed from one to another.

A step S2 following the step S1 divides every 1-frame-corresponding portion of the digital image signal into segments (data blocks) representing respective equal-size rectangular or square blocks PB composing the frame. The blocks PB composing the frame have serial ID numbers (serial address numbers), respectively. The block ID numbers are in the range between “1” and “(W/X)·(H/Y)”.

A step S3 subsequent to the step S2 sets the counter value C to a starting value which corresponds to an in-frame position from which the embedding of the encrypted information commences. After the step S3, the program advances to a step S4.

The step S4 computes the sum SUM of the luminance values of pixels composing the block PB having an ID number equal to the counter value C. In addition, the step S4 computes a mean or an average AVG among the luminance values of pixels composing the block PB having the ID number equal to the counter value C. The step S4 corresponds to the parameter calculator 22 in FIG. 1.

A step S5 following the step S4 retrieves one among the bits composing the encrypted information which has an ID number equal to the value M. For the block PB having the ID number equal to the counter value C, the step S5 computes a corrective luminance value (difference value) A from the retrieved bit of the encrypted information, the luminance value sum SUM, and the average luminance value AVG as the addition/subtraction quantity calculator 23 in FIG. 1 does.

A step S6 subsequent to the step S5 accesses the set of the random integers in the table 26. The step S6 alters or modifies one or more of the random integers in response to the difference value (corrective luminance value) Δ as the embedded random number generator 25 in FIG. 1 does. Therefore, the original random integer set is changed into a modified set having the modified random integers and some of the original random integers. The step S6 generates a signal representing the modified random integer set.

A step S7 following the step S6 adds the signal of the modified random integer set to the luminance signal in the digital image signal on a pixel-by-pixel basis. Specifically, the step S7 adds a random integer in the modified set to the luminance value of a corresponding pixel represented by the digital image signal. The addition is implemented for each of pixels composing the block PB so that the digital image signal is converted into a luminance-altered digital image signal.

A step S8 subsequent to the step S7 decides whether or not the counter value C is equal to “(W/X)·(H/Y)”, that is, whether or not the processing of all the blocks PB composing the frame has been completed. When the counter value C is equal to “(W/X)·(H/Y)”, that is, when the processing of all the blocks PB has been completed, the program exits from the step S8 and then the current execution cycle of the main program segment ends. Otherwise, the program advances from the step S8 to a step S9.

The step S9 increments the counter value C by “1” according to the program statement “C←C+1”. In addition, the step S9 increments the counter value M by “1” according to the program statement “M←M+1”. After the step S9, the program returns to the step S4.

In this way, the recording apparatus 2A generates the luminance-altered digital image signal. The recording apparatus 2A outputs the luminance-altered digital image signal to the transmission line 1 via the I/O port 44. The luminance-altered digital image signal propagates to the reproducing apparatus 3A along the transmission line 1.

As shown in FIG. 5, the reproducing apparatus 3A includes a microcomputer having a combination of a ROM 51, a CPU 52, a RAM 53, and an I/O port 54. The ROM 51, the CPU 52, the RAM 53, and the I/O port 54 are connected via a bus. The I/O port 54 is coupled with the transmission line 1. The I/O port 54 receives a luminance-altered digital image signal from the transmission line 1. The reproducing apparatus 3A or the microcomputer therein operates in accordance with a control program stored in the ROM 51. During operation of the reproducing apparatus 3A, a sequence of steps in the control program is executed by the CPU 52.

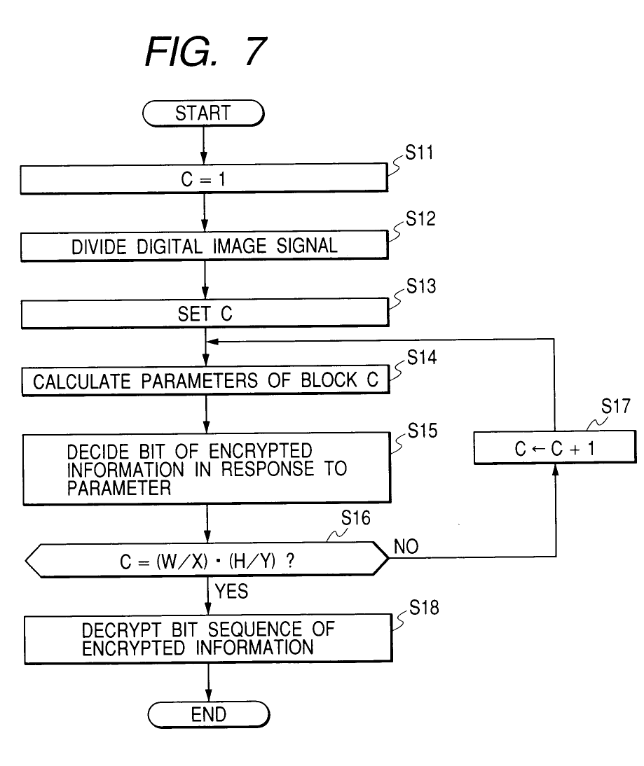

FIG. 7 is a flowchart of a main segment of the control program for the reproducing apparatus 3A. The main program segment is executed for every frame represented by the received digital image signal.

As shown in FIG. 7, a first step S11 of the main program segment initializes a variable C to “1”. The variable C is used as a counter value C for denoting a block PB which is periodically changed from one to another along a normal scanning order (the left to the right and the top to the bottom in a frame).

A step S12 following the step S11 divides every 1-frame-corresponding portion of the received digital image signal into segments (data blocks) representing respective blocks PB composing the frame. The blocks PB composing the frame have serial ID numbers (serial address numbers), respectively. The block ID numbers are in the range between “1” and “(W/X)·(H/Y)”.

A step S13 subsequent to the step S12 sets the counter value C to a starting value which corresponds to an in-frame position from which the detection of the encrypted information commences. After the step S13, the program advances to a step S14.

The step S14 computes an average among the luminance values of pixels composing the block PB having an ID number equal to the counter value C. The step S14 corresponds to the parameter calculator 32 in FIG. 1.

A step S15 following the step S14 determines whether the average luminance value given by the step S14 is odd or even. When the average luminance value is odd, the step S15 decides that a corresponding bit of encrypted information is “0”. On the other hand, when the average luminance value is even, the step S15 decides that the corresponding bit of encrypted information is “1”. The step S15 stores the decided bit of encrypted information into the RAM 53. The step S15 corresponds to the deciding and extracting device 33 in FIG. 1.

A step S16 subsequent to the step S15 decides whether or not the counter value C is equal to “(W/X)·(H/Y)”, that is, whether or not the processing of all the blocks PB composing the frame has been completed. When the counter value C is equal to “(W/X)·(H/Y)”, that is, when the processing of all the blocks PB has been completed, the program advances from the step S16 to a step S18. Otherwise, the program advances from the step S16 to a step S17.

The step S17 increments the counter value C by “1” according to the program statement “C←C+”. After the step S17, the program returns to the step S14.

The step S18 reads out the bit sequence of encrypted information from the RAM 53. The step S18 decrypts the encrypted information (the bit sequence) according to a decryption algorithm stored in the ROM 51, and thereby recovers original information therefrom. The step S18 corresponds to the decryptor 34 in FIG. 1. After the step S18, the current execution cycle of the main program segment ends.

In this way, the reproducing apparatus 3A recovers the original information from the encrypted information. The reproducing apparatus 3A outputs the recovered information via the I/O port 54.

It should be noted that the I/O port 54 passes the luminance-altered digital image signal to a main information reproducing apparatus (not shown).

### Eighth Embodiment

An eighth embodiment of this invention is similar to the seventh embodiment thereof except for design changes mentioned hereafter. In the eighth embodiment of this invention, the step S8 (see FIG. 6) decides whether or not the counter value C is equal to a predetermined value different from “(W/X)·(H/Y)”. When the counter value C is equal to the predetermined value, the program exits from the step S8 and then the current execution cycle of the main program segment ends. Otherwise, the program advances from the step S8 to the step S9.

In the eighth embodiment of this invention, the step S16 (see FIG. 7) decides whether or not the counter value C is equal to the predetermined value. When the counter value C is equal to the predetermined value, the program advances from the step S16 to the step S18. Otherwise, the program advances from the step S16 to the step S17.

### Ninth Embodiment

A ninth embodiment of this invention is similar to one of the first to eighth embodiments thereof except for design changes mentioned hereafter. The ninth embodiment of this invention uses a color-related statistical condition of a digital image signal while the first to eighth embodiments of this invention use the luminance-related statistical condition thereof. In the ninth embodiment of this invention, the luminance-related statistical condition of the digital image signal is modified in response to encrypted information to implement the embedding of the encrypted information.

### ADVANTAGES PROVIDED BY THE INVENTION

Every 1-frame-corresponding portion of the digital image signal is divided into segments representing blocks composing the frame. The information to be embedded is encrypted. Bits composing the resultant encrypted information are assigned to blocks, respectively. A bit of the resultant encrypted information is used in calculating the difference value (corrective luminance value) Δ for a corresponding block. The set of the random integers is modified in response to the calculated difference value Δ. The random integers in the resultant modified set are combined with the luminance values of pixels of the corresponding block represented by the digital image signal. As a result, the encrypted information is embedded in the digital image signal.

The embedding of the encrypted information can be implemented by a simpler and cheaper apparatus. The reproduction of the encrypted information can be implemented by a simpler and cheaper apparatus. The embedding of the encrypted information can be quickly done. The reproduction of the encrypted information can be quickly done. The use of the random integers provides effects similar to those of spread spectrum techniques. Therefore, the encrypted information in the digital image signal has a high resistance to an illegal attack such as an information altering attack.

What is claimed is:

1. A system for transmitting and receiving encrypted information, comprising an encrypted information recording apparatus, an encrypted information reproducing apparatus, and a transmission line connecting the encrypted information recording apparatus and the encrypted information reproducing apparatus, the encrypted information recording apparatus transmitting a digital information signal to the encrypted information reproducing apparatus via the transmission line, the digital information signal resulting from embedding encrypted information in a digital contents signal, the encrypted information reproducing apparatus receiving the digital information signal and reproducing the encrypted information from the digital information signal;
wherein the encrypted information recording apparatus comprises:
first means for dividing the digital contents signal into first data blocks;
second means for calculating a statistical quantity of the digital contents signal for every first data block generated by the first means;
third means for encrypting information to be embedded into the encrypted information;
fourth means for calculating a corrective quantity from the encrypted information and the statistical quantity calculated by the second means;
fifth means for changing first random numbers into second random numbers in response to the corrective quantity calculated by the fourth means, and for generating a signal representative of the second random numbers; and
sixth means for adding the signal representative of the second random numbers to the digital contents signal for every first data block generated by the first means to embed the encrypted information in the digital contents signal and thereby generate the digital information signal; and
wherein the encrypted information reproducing apparatus comprises:
seventh means for dividing the digital information signal into second data blocks corresponding to the first data blocks generated by the first means;
eighth means for calculating the statistical quantity of the digital information signal for every second data block generated by the seventh means;
ninth means for deciding the encrypted information in the digital information signal in response to the statistical quantity calculated by the eighth means for every second data block generated by the seventh means to extract the encrypted information from the digital information signal; and
tenth means for decrypting the encrypted information extracted by the ninth means into the original information to be embedded.

2. In a system comprising an encrypted information recording apparatus, an encrypted information reproducing apparatus, and a transmission line connecting the encrypted information recording apparatus and the encrypted information reproducing apparatus, the encrypted information recording apparatus transmitting a digital information signal to the encrypted information reproducing apparatus via the transmission line, the digital information signal resulting from embedding encrypted information in a digital contents signal, the encrypted information reproducing apparatus receiving the digital information signal and reproducing the encrypted information from the digital information signal, a method of transmitting and receiving encrypted information which comprises a recording-related method and a reproducing-related method;
wherein the recording-related method comprises the steps of:
dividing the digital contents signal into first data blocks;
calculating a statistical quantity of the digital contents signal for every first data block;
encrypting information to be embedded into the encrypted information;
calculating a corrective quantity from the encrypted information and the calculated statistical quantity;
changing first random numbers into second random numbers in response to the calculated corrective quantity, and generating a signal representative of the second random numbers; and
adding the signal representative of the second random numbers to the digital contents signal for every first data block to embed the encrypted information in the digital contents signal and thereby generate the digital information signal; and
wherein the reproducing-related method comprises the steps of:
dividing the digital information signal into second data blocks corresponding to the first data blocks;
calculating the statistical quantity of the digital information signal for every second data block;
deciding the encrypted information in the digital information signal in response to the calculated statistical quantity of the digital information signal for every second data block to extract the encrypted information from the digital information signal; and
decrypting the extracted encrypted information into the original information to be embedded.

3. A computer program for embedding encrypted information in a digital contents signal, comprising the steps of:
dividing the digital contents signal into data blocks;
calculating a statistical quantity of the digital contents signal for every data block;
encrypting information to be embedded into the encrypted information;
calculating a corrective quantity from the encrypted information and the calculated statistical quantity;
changing first random numbers into second random numbers in response to the calculated corrective quantity, and generating a signal representative of the second random numbers; and
adding the signal representative of the second random numbers to the digital contents signal for every data block to embed the encrypted information in the digital contents signal.

4. An apparatus comprising:
first means for dividing a digital contents signal into segments;
second means for detecting a condition of the digital contents signal for every segment generated by the first means;
third means for determining a corrective quantity in response to auxiliary information and the condition detected by the second means;
fourth means for changing first random numbers into second random numbers in response to the corrective quantity determined by the third means, and for generating a signal representative of the second random numbers; and
fifth means for adding the signal representative of the second random numbers to the digital contents signal for every segment generated by the first means to embed the auxiliary information in the digital contents signal.

5. An apparatus as recited in claim 4, wherein the condition detected by the second means is an average-luminance-related condition.

6. An apparatus as recited in claim 4, further comprising sixth means for encrypting the auxiliary information before the auxiliary information is used by the third means.

7. An apparatus comprising:
first means for dividing a digital contents signal into segments;
second means for detecting an average luminance value of the digital contents signal for every segment generated by the first means;
third means for determining a corrective quantity in response to a bit of auxiliary information and the average luminance value detected by the second means for every segment generated by the first means, wherein bits of the auxiliary information are assigned to the segments generated by the first means respectively;
fourth means for changing first random numbers into second random numbers in response to the corrective quantity determined by the third means, and for generating a signal representative of the second random numbers; and
fifth means for adding the signal representative of the second random numbers to the digital contents signal for every segment generated by the first means to embed the auxiliary information in the digital contents signal and thereby generate a composite digital signal, wherein an average luminance value of every segment of the composite digital signal is either odd or even depending on a logic state of a corresponding bit of the auxiliary information.

8. An apparatus as recited in claim 7, further comprising sixth means for encrypting the auxiliary information before the auxiliary information is used by the third means.

9. An apparatus comprising:
first means for dividing a digital information signal into segments;
second means for detecting an average luminance value of the digital information signal for every segment generated by the first means;
third means for deciding whether the average luminance value detected by the second means is odd or even; and
fourth means for detecting auxiliary information in the digital information signal in response to results of the deciding by the third means.

10. An apparatus as recited in claim 9, further comprising fifth means for decrypting the auxiliary information detected by the fourth means.

11. A computer program comprising the steps of:
dividing a digital information signal into segments;
detecting an average luminance value of the digital information signal for every segment;
deciding whether the detected average luminance value is odd or even;
detecting encrypted information in the digital information signal in response to results of the deciding; and
decrypting the detected encrypted information.
